(19) United States
(12) Patent Application Publication
(10) Pub. No.: US 2009/0105903 A1
(43) Pub. Date: Apr. 23, 2009

(54) MALFUNCTION RECORDING DEVICE

(75) Inventor: Atsushi IWAI, Tajimi-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/252,530

(22) Filed: Oct. 16, 2008

(30) Foreign Application Priority Data
Oct. 17, 2007 (JP) 2007-270158

(51) Int. Cl. G06F 19/00

(52) U.S. Cl. 701/35

(57) ABSTRACT

A malfunction recording device includes: a detection section that detects diagnostic trouble codes of a vehicle; a recording section that records the diagnostic trouble codes and operates in an inspection mode or a normal mode; a switch section that changes the operation mode of the recording section between the inspection mode and the normal mode; a determination section that determines whether the vehicle is in motion; a volatile memory section, into which the recording section records the diagnostic trouble codes either in the inspection mode or in the normal mode; a nonvolatile memory section, into which the recording section records the diagnostic trouble codes in the normal mode. If the determination section determines that the vehicle is in motion, the switch section changes the operation mode of the recording section from the inspection mode to the normal mode.

### INCORPORATION BY REFERENCE

The disclosure of Japanese Patent Application No. 2007-270158 filed on Oct. 17, 2007 including the specification, drawings and abstract is incorporated herein by reference in its entirety.

### BACKGROUND OF THE INVENTION

1. Field of the Invention

The present invention relates to a malfunction recording device applied to vehicles such as automobiles, trucks, and buses.

2. Description of the Related Art

Some vehicles are equipped with an exhaust gas purification device that reduces air pollution. It is obligatory for such vehicles to be equipped with an On-Board Diagnostics (OBD), which alerts the driver when a malfunction has occurred in the exhaust gas purification device, and records diagnostic trouble codes that include a diagnostic result in both nonvolatile memory and volatile memory of an ECU (Electronic Control Unit) described in Japanese Utility Model Application Publication No. 2-49772 (JP-U-2-49772). Here, the nonvolatile memory is a memory suitable for permanent recording. The volatile memory has faster response speed compared to the nonvolatile memory, and is suited for temporary data recording.

The malfunction recording device of this type records produced DTC (Diagnostic Trouble Code) in the nonvolatile memory. Scan tool is used to read DTC recorded in the nonvolatile memory in order to determine the cause of the malfunction.

To further reduce air pollution, exhaust gas restriction has become more stringent. Accordingly, further requirements tend to be added to the malfunction recording device described above. Previously, the DTC recorded in the nonvolatile memory could be erased through an erase function of the scan tool, after a cause of malfunction is identified and corrected by appropriate service. However, according to recent legal requirements to improve the security of record retention, when a malfunction is detected, the DTC recorded in the nonvolatile memory may be no longer erased by the scan tool.

The malfunction recording device described above records detected malfunctions in the nonvolatile memory. Accordingly, malfunction records from factory inspections are recorded permanently. A problem is that it is not possible to determine whether the malfunction record recorded in the nonvolatile memory is a DTC from factory inspection or whether it is a DTC from normal use.

### SUMMARY OF THE INVENTION

The present invention provides a malfunction recording device for vehicle, that enables discrimination of DTC by providing a slight control change, so that it may be applied to various vehicles such as automobiles, trucks, buses, and so on.

A malfunction recording device according to a first aspect of the present invention includes: a detection section that detects DTC of a vehicle; a recording section that records the DTC and operates in an inspection mode or a normal mode; a switch section that changes the operation mode of the recording section between the inspection mode and the normal mode; a determination section that determines whether the vehicle is in motion; a volatile memory section, into which the recording section records the DTC when operating in the inspection mode or in the normal mode; a nonvolatile memory section, into which the recording section records the DTC when operating in the normal mode. If the determination section determines that the vehicle is in motion, the switch section changes the operation mode of the recording section to the normal mode.

A malfunction recording device according to a second aspect of the present invention includes: a detection section that detects DTC of a vehicle; a recording section that records the DTC and operates in an initial mode or a normal mode; a switch section that changes the operation mode of the recording section between the initial mode and the normal mode; a determination section that determines whether the vehicle is in motion or whether the detection section has detected a DTC; a volatile memory section, into which the recording section records the DTC when operating in the initial mode or in the normal mode; a nonvolatile memory section, into which the recording section records the DTC when operating in the normal mode. If the determination section determines that the vehicle is in motion or the detection section has detected a DTC, the switch section changes the operation mode of the recording section to the normal mode.

A malfunction recording device according to a third aspect of the present invention includes: a detection section that detects DTC of a vehicle; a recording section that records the DTC and operates in an initial mode, an inspection mode, or a normal mode; a switch section that changes the operation mode of the recording section among the initial mode, the inspection mode, and the normal mode; a determination section that determines whether the vehicle is in motion or whether the detection section has detected a DTC; a volatile memory section, into which the recording section records the DTC when operating in the initial mode, in the inspection mode, or in the normal mode; a nonvolatile memory section, into which the recording section records the DTC when operating in the normal mode. When the recording section operating in the inspection mode, and if the determination section determines that the vehicle is in motion or the detection section has detected a DTC, the switch section changes the operation mode of the recording section from the initial mode to the normal mode. When the recording section operating in the inspection mode, and if the determination section determines that the vehicle is in motion, the switch section changes the operation mode of the recording section from the inspection mode to the normal mode

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram showing a malfunction recording device according to an embodiment of the present invention;

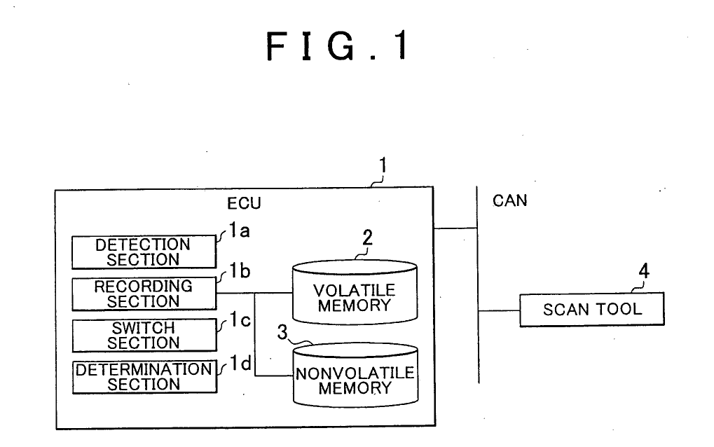

FIG. 2 is a state diagram showing a state of each mode of an ECU of a malfunction recording device according to an embodiment of the present invention;

FIG. 3 is a flow chart showing the control of a malfunction recording device according to an embodiment of the present invention;

FIG. 4 is a flow chart showing the control of a malfunction recording device according to an embodiment of the present invention; and

FIG. 5 is a flow chart showing the control of a malfunction recording device according to an embodiment of the present invention.

### DETAILED DESCRIPTION OF EMBODIMENTS

An ECU 1, which functions as the malfunction recording device according to the present invention, includes a CPU; a ROM; a DRAM (Dynamic Random Access Memory); a flash memory; all of which are connected to a data bus. The CPU executes the following processes according to a program stored in the ROM.

That is, the CPU functions as a detection section 1a, a recording section 1b, a switch section 1c, and a determination section 1d. The DRAM (Dynamic Random Access Memory) functions as a volatile memory 2, which is a volatile memory section. The flash memory functions as a nonvolatile memory 3, which is a nonvolatile memory section.

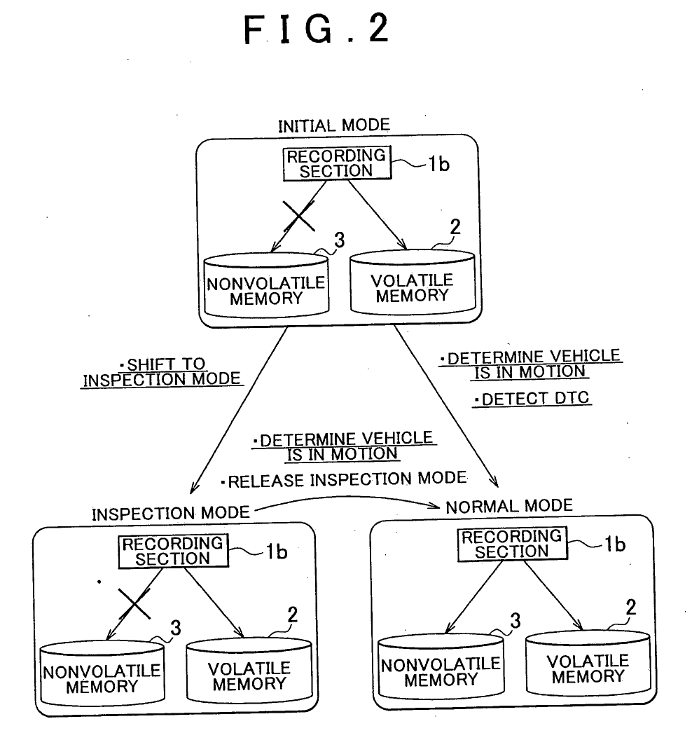

A scan tool 4 is connected to the ECU 1 through a communication standard such as a CAN (Controller Area Network). As shown in FIG. 2, the ECU 1 has three operational modes, which are the initial mode, the inspection mode, and the normal mode. The mode may be changed by the requirement of the switch section 1c or the scan tool 4. Also, the mode may be changed using an inspection completion flag. The ECU 1 includes a mode display lamp not shown on the surface of a housing. The mode display lamp flashes during the inspection mode.

The inspection mode is used when a malfunction diagnosis is performed while the scan tool 4 is connected at the factory or a dealer. The initial mode indicates that the ECU 1 is brand new, in other words, that the ECU has been shipped directly from the manufacturer. The normal mode is used when the inspection mode or the initial mode is not set. In other words, the normal mode is used during normal driving of the vehicle.

Among various ECUs, the ECU 1 may be an engine ECU or a transmission ECU, which are especially related to exhaust gas restrictions. However, the ECU 1 may be a separate ECU that is connected to the engine ECU or the transmission ECU via the CAN.

The DRAM of the volatile memory section is the volatile memory 2 formed by semiconductors, and has a characteristic that a record is not retained after power supply is disconnected. The volatile memory section temporarily records information related to breakdowns or malfunctions of the vehicle (hereinafter referred to as diagnostic trouble code or DTC).

In contrast, the flash memory of the nonvolatile memory section is the nonvolatile memory 3 formed by semiconductors, and has a characteristic that a record is retained after power supply is disconnected. The nonvolatile memory section records the DTC permanently.

The detection section 1a diagnoses a vehicle state and detects DTC. For example, the detection section 1a diagnoses a fuel combustion state or the like based on signals received from: an O₂ sensor that measures the concentration of oxygen supplied to a combustion chamber; a coolant temperature sensor that measures the temperature of coolant used to cool the engine; an air flow sensor that measures the flow rate of air supplied to the combustion chamber; and a vacuum sensor that measures the degree of vacuum of the intake manifold. The detection section 1a detects a breakdown of engine or an abnormal fuel combustion state, and detects DTC when a breakdown or a malfunction occurs.

The detection section 1a diagnoses a vehicle state and detects DTC, in the normal mode, during normal (daily) driving of vehicle. Furthermore, the detection section 1a diagnoses a vehicle state in a vehicle manufacturing factory or the like, in the inspection mode, by a test or the like before shipping the vehicle, and also detects DTC. When the ECU 1 is shipped from a factory, the detection section 1a detects DTC also in the initial mode.

As shown in FIG. 2, in the inspection mode and the initial mode, the recording section 1b records DTC only in the DRAM. In the normal mode, the recording section 1b records DTC both in the DRAM and in the flash memory. Here, “X” in FIG. 2 indicates that a record is prohibited.

The determination section 1d determines that the vehicle is in motion if the vehicle satisfies predetermined conditions or if a certain period of time has elapsed from a reference time. At the same time, the determination section 1d determines the operational mode of the ECU 1.

As shown in FIG. 2, when the operation mode is the inspection mode and if the determination section 1d determines that the vehicle is in motion, the switch section 1c changes the operational mode from the inspection mode to the normal mode. In addition, the recording section 1b records an inspection completion flag in the nonvolatile memory. When the operation mode is the initial mode and if the determination section 1d determines that the vehicle is in motion, the switch section 1c changes the operational mode from the initial mode to the normal mode, as shown in FIG. 2. Also as shown in FIG. 2, when the operation mode is the initial mode and if the detection section 1a detects a DTC, the switch section 1c changes the operational mode from the initial mode to the normal mode.

The scan tool 4 reads DTCs recorded in the ECU 1. For example, by using the scan tool 4, DTCs recorded in the volatile memory 2 or the nonvolatile memory 3 may be read in real time, and DTCs recorded in the nonvolatile memory 3 may be read afterward. When the scan tool 4 requests the ECU 1 to changes modes, the ECU 1 changes the operation mode from the initial mode to the inspection mode, or changes the operation mode from the inspection mode to the normal mode. The scan tool 4 may be connected to the ECU 1 through the CAN, and removed at the dealer after completing the inspection. The scan tool 4 is not mounted on vehicle during normal driving.

When the operation mode is changed to the inspection mode and inspection is completed, the scan tool 4 records an inspection completion flag in the nonvolatile memory 3. Accordingly, the ECU 1 changes the operation mode from the inspection mode to the normal mode. However, if the inspection completion flag is not recorded to the nonvolatile memory 3 due to an error in the scan tool 4, the operation mode is not changed back to the normal mode.

Here, “real time” indicates that power is supplied to the ECU 1 and the most recent DTC is read as soon as the signals are received from various sensors or the like. “Afterward” indicates that power of the ECU 1 is once turned off and then these recorded past DTC has read in a state where DTC is already recorded in the nonvolatile memory 3. DTC recorded in the nonvolatile memory 3 is retained after power of ECU 1 is once turned off.

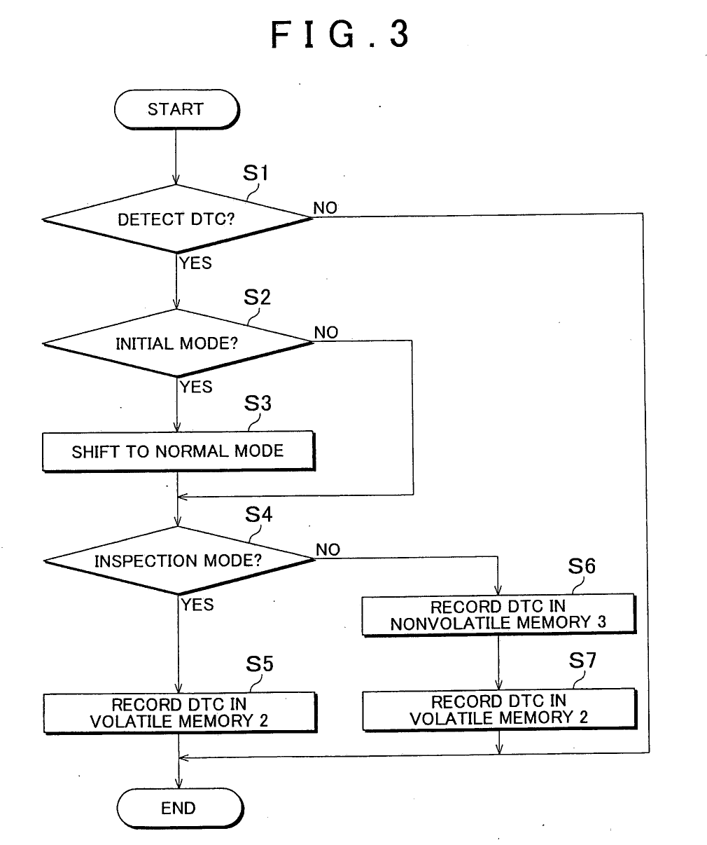

Hereinafter, the control of the ECU 1 in the present embodiment are described based on flowcharts and state diagrams of FIGS. 3 to 5.

As shown in FIG. 3, in S1, the determination section 1d determines whether the detection section 1a detects a DTC. If yes, the process proceeds to S2, and if not, the control ends.

In S2, the determination section 1d determines whether the operation mode of the ECU 1 is the initial mode. If yes, the process proceeds to S3. If not, the process skips S3 and proceeds to S4.

In S3, the switch section 1c changes the operation mode of the ECU 1 to the normal mode. In S4, the determination section 1d determines whether the operation mode of the ECU 1 is the inspection mode. If yes, the process proceeds to S5, where the recording section 1b records the DTC in the volatile memory 2.

If no in S4, the process proceeds to S6, where the recording section 1b records the DTC in the nonvolatile memory 3. And in S7, the recording section 1b records the DTC in the volatile memory 2.

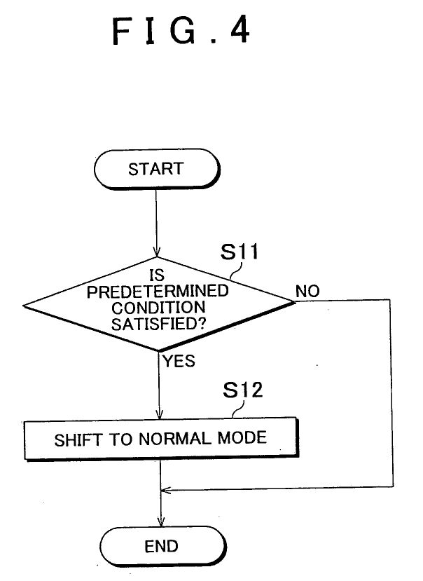

If operation mode of the ECU 1 is the initial mode or the inspection mode, the operation mode is changed to the normal mode by executing an appropriate control if it is determined that the vehicle is in motion. It is determined that the vehicle is in motion when the vehicle satisfies a predetermined condition. The control is executed according to a flowchart shown in FIG. 4. For example, in S11, the determination section 1d determines whether predetermined condition such as idling for 30 seconds, traveling at a speed of more than 40 km/h for 300 seconds, and 600 seconds has elapsed since engine-start are satisfied. If yes, the process proceeds to S12. In S12, the switch section 1c changes the operation mode of the ECU 1 to the normal mode.

According to the embodiment described above, by using a simple determination element, the switch section 1c may change the operation mode from the inspection mode to the normal mode, and also may change the operation mode from the initial mode to the normal mode.

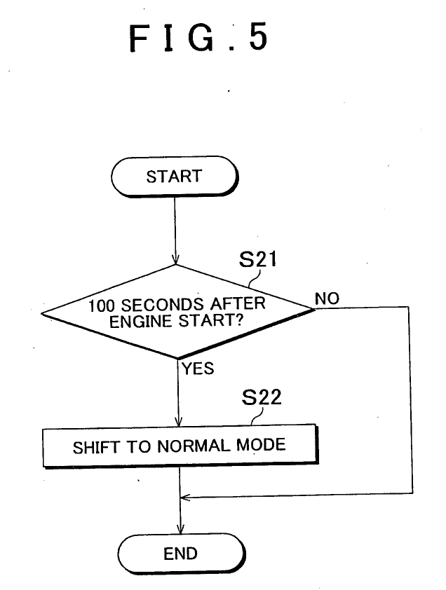

Alternatively if the operation mode of the ECU 1 is the initial mode or the inspection mode and it is determined that the vehicle is in motion after 100 seconds has elapsed after engine-start, the operation mode is changed to the normal mode. The control in this case is executed according to the flowchart shown in FIG. 5.

In this way also, using a simple determination element, the switch section can change the operation mode from the inspection mode or the initial mode to the normal mode.

That is, in S21, the determination section 1d determines whether 100 seconds have elapsed after engine-start. If yes, the process proceeds to S22, and the switch section 1c changes the operation mode of the ECU 1 to the normal mode. The control shown in FIG. 5 has fewer determination elements compared to the control shown in FIG. 4, thus the operation mode can be changed to the normal mode faster.

According to the malfunction-recording device of the embodiments described above, the following functions and effects are obtained.

The determination section 1d of the ECU 1determines that the vehicle is driving in motion if predetermined period of time has elapsed from a reference time. That is, if the determination section 1d of the ECU 1determines that the vehicle is driving in motion, by using simple determination elements, as shown in FIG. 2, the switch section 1c can change the operational mode to the normal mode.

Alternatively, if the determination section 1d of the ECU 1 determines that the vehicle is in motion when the predetermined condition is satisfied. That is, if the determination section 1d of the ECU 1 determines that the vehicle is driving in motion, by using simple determination elements, as shown in FIG. 2, the switch section 1c can change a mode to the normal mode.

Furthermore, in the inspection mode and the initial mode, the recording section 1b records DTC in the volatile memory 2 only. Therefore, permanent retention in the nonvolatile memory 3 of a DTC from a factory inspection is avoided. Accordingly, when data is read by the scan tool 4, it is possible to determine whether the recorded DTC is recorded during factory inspection or whether it is recorded during normal use.

As described above, when the operation mode is changed to the inspection mode and inspection is completed as required by the scan tool 4, the scan tool 4 records an inspection completion flag in the nonvolatile memory 3. Accordingly the ECU 1 changes the operation mode from the inspection mode to the normal mode. However, if the inspection completion flag is not recorded in the nonvolatile memory 3 due to an error in the scan tool 4, the operation mode is not changed from the inspection mode to the normal mode.

In this case, in normal driving, the ECU 1 remains in the inspection mode, and the recording section 1b is prevented from recording the DTC in the nonvolatile memory 3. The recording section 1b is also prevented from recording the DTC in the nonvolatile memory 3 if failure to change the operation mode from the normal mode to the inspection mode is due to an error in the ECU 1.

Thus, as shown in the present embodiment, if the determination section 1d determines that the vehicle is in motion, the switch section 1c changes the operational mode from the inspection mode to the normal mode as shown in FIG. 2. Accordingly, under normal driving, it is possible to avoid the situation where an inspection completion flag is not recorded in the nonvolatile memory 3 due to an error in the scan tool 4, and where failure to change the operation mode to the inspection mode due to an error in the ECU 1. Furthermore, it is possible to avoid the situation where the recording section 1b is prevented from recording the DTC in the nonvolatile memory 3.

Furthermore, if the determination section 1d determines that the vehicle is in motion or that the detection section l a detects DTC, as shown in FIG. 2, the switch section 1c changes the operational mode from the initial mode to the normal mode. For example, when the ECU 1 is swapped with a new one at a dealer, operation of the ECU 1 in the initial mode during normal driving and it the inability of the recording section 1b to record the DTC in the nonvolatile memory 3 may both be prevented.

Although the embodiments of the present invention have been described in detail, the present invention is not restricted to the described embodiments, and various modification and replacement to the embodiments may be allowed without departing from the scope of the invention.

For example, in the embodiments described above, the volatile memory section is provided as the DRAM, and the nonvolatile memory section is provided as the flash memory. However, the volatile memory section and the nonvolatile memory section may be other forms.

Also, in the embodiments described above, the determination section 1d uses a elapsed time of 100 seconds after engine-start as a threshold measure of whether the vehicle is in motion, which is an example of a certain elapsed time from a reference time. However, the reference time may be set as idle start time, engine start time, the time when the vehicle starts moving, and the time when the vehicle speed reaches at of 40 km/h.

Furthermore, instead of a certain elapsed time from a reference time, a certain distance traveled may be used as the threshold measure.

According to the embodiments described above, in the inspection mode and the initial mode, the recording section records the DTC in the volatile memory section only. Therefore, permanent retention in the nonvolatile memory section of DTC during factory inspection is avoided. Accordingly, it is possible to deter-mine whether the recorded DTC is a DTC from the factory inspection or whether it is a DTC from normal use when data is read by the scan tool.

In addition, when the operation mode is inspection mode and if the determination section determines that the vehicle is in motion, the switch section changes the operational mode from the inspection mode to the normal mode. Therefore, during normal driving, the malfunction recording device prevents the failure to write an inspection completion flag due to an error in the scan tool or due to an erroneous change of the operation mode to the inspection mode due to an error in the malfunction-recording device itself It can be prevented that the recording section cannot record the DTC to the nonvolatile memory section.

Furthermore, when the operation mode is initial mode and if the determination section determines that the vehicle is in motion or that the detection section detects DTC, the switch section changes the operational mode from the initial mode to the normal mode. Therefore, for example when the malfunction recording device is changed to a new one, during normal driving, it can be prevented that the malfunction recording device remains in the initial mode. In addition, the recording section is not prohibited from recording the DTC in the nonvolatile memory section.

What is claimed is:

1. A malfunction recording device comprising:
a detection section that detects diagnostic trouble codes of a vehicle;
a recording section that records the diagnostic trouble codes and operates in an inspection mode or a normal mode;
a switch section that changes the operation mode of the recording section between the inspection mode and the normal mode;
a determination section that determines whether the vehicle is in motion;
a volatile memory section, into which the recording section records the diagnostic trouble codes when operating in either in the inspection mode or in the normal mode; and
a nonvolatile memory section, into which the recording section records the diagnostic trouble codes when operating in the normal mode,
wherein if the determination section determines that the vehicle is in motion, the switch section changes the operation mode of the recording section to the normal mode.

2. The malfunction recording device according to claim 1, wherein the determination section determines that the vehicle is in motion after a predetermined amount of time has elapsed from a reference time.

3. The malfunction recording device according to claim 2, wherein the reference time is one of an idling start time, an engine-start time, and a time when the vehicle starts moving.

4. The malfunction recording device according to claim 1, wherein the determination section determines that the vehicle is in motion when a predetermined condition is satisfied.

5. The malfunction recording device according to claim 1, wherein the determination section determines that the vehicle is in motion after a predetermined distance has been traveled.

6. The malfunction recording device according to claim 1, wherein the recording section records an inspection completion flag in the nonvolatile memory section when the operation mode of the recording section is changed from the inspection mode to the normal mode.

7. A malfunction recording device comprising:
a detection section that detects diagnostic trouble codes of a vehicle;
a recording section that records the diagnostic trouble codes and operates in an initial mode or a normal mode;
a switch section that changes the operation mode of the recording section between the initial mode and the normal mode;
a determination section that determines whether the vehicle is in motion or whether the detection section has detected a diagnostic trouble code;
a volatile memory section, into which the recording section records the diagnostic trouble codes when operating in either in the initial mode or in the normal mode; and
a nonvolatile memory section, into which the recording section records the diagnostic trouble codes when operating in the normal mode,
wherein if the determination section determines that the vehicle is in motion or the detection section has detected a diagnostic trouble code, the switch section changes the operation mode of the recording section to the normal mode.

8. The malfunction recording device according to claim 7, wherein the determination section determines that the vehicle is in motion after a predetermined amount of time has elapsed from a reference time.

9. The malfunction recording device according to claim 8, wherein the reference time is one of an idling start time, an engine-start time, and a time when the vehicle starts moving.

10. The malfunction recording device according to claim 7, wherein the determination section determines that the vehicle is in motion when a predetermined condition is satisfied.

11. The malfunction recording device according to claim 7, wherein the determination section determines that the vehicle is in motion after a predetermined distance has been traveled.

12. A malfunction recording device comprising:
a detection section that detects diagnostic trouble codes of a vehicle;
a recording section that records the diagnostic trouble codes and operates in an initial mode, an inspection mode, or a normal mode;
a switch section that changes the operation mode of the recording section among the initial mode, the inspection mode, and the normal mode;
a determination section that determines whether the vehicle is in motion or whether the detection section has detected a diagnostic trouble code;
a volatile memory section, into which the recording section records the diagnostic trouble codes when operating in the initial mode, in the inspection mode, or in the normal mode; and
a nonvolatile memory section, into which the recording section records the diagnostic trouble codes when operating in the normal mode,
wherein when the recording section operating in the initial mode, and if the determination section determines that the vehicle is in motion or the detection section has detected a diagnostic trouble code, the switch section changes the operation mode of the recording section from the initial mode to the normal mode, and
wherein when the recording section operating in the inspection mode, and if the determination section determines that the vehicle is in motion, the switch section changes the operation mode of the recording section from the inspection mode to the normal mode.
